(19) United States
(12) Patent Application Publication
(10) Pub. No.: US 2017/0316099 A1
(43) Pub. Date: Nov. 2, 2017

(54) SYSTEM AND METHOD FOR IDENTIFYING USER INTERESTS THROUGH SOCIAL MEDIA

(71) Applicant: HRL Laboratories, LLC, Malibu, CA (US)

(72) Inventors: Jiejun Xu, Chino, CA (US); Tsai-Ching Lu, Thousand Oaks, CA (US)

(21) Appl. No.: 15/231,346

(22) Filed: Aug. 8, 2016

Related U.S. Application Data
(60) Provisional application No. 62/201,738, filed on Aug. 6, 2015.

(51) Int. Cl. G06F 17/30; G06Q 50/00; G06Q 30/02

(52) U.S. Cl. CPC G06F 17/30867; G06Q 30/0255; G06Q 50/01

(57) ABSTRACT

Described is a system for discovering user interests through online social media, and more specifically, to a way of doing so by means of a bi-directional graph model. During operation, the system generates a confidence matrix F based on user interactions and co-occurring tags on a social media platform. The confidence matrix F indicates a likelihood of the users in the social media platform as being interested in a particular topic. Based on such likelihoods, an action can be initiated regarding a particular topic for those users whose likelihood of being interested in the particular topic exceeds a predetermined threshold. For example, the system generates and presents an online advertisement to users regarding a particular topic to those users whose likelihood of being interested in the particular topic exceeds a predetermined threshold.

### CROSS-REFERENCE TO RELATED APPLICATIONS

This is a non-provisional patent application of U.S. Provisional Application No. 62/201,738, filed on Aug. 6, 2015, the entirety of which is hereby incorporated by reference.

### GOVERNMENT RIGHTS

This invention was made with government support under U.S. Government Contract Number D12PC00285 issued by IARPA. The government has certain rights in the invention.

### BACKGROUND OF INVENTION

### (1) Field of Invention

The present invention relates to a system for discovering user interests and, more specifically, to a system for discovering user interests through online social media using a bi-directional graph model.

### (2) Description of Related Art

There has been a growing interest on discovering user interests and topics from online social media (See the list of Incorporated Literature References, References Nos. 3 and 4). A common approach is to use a vector representation generated from the text of all the posts by a user to represent his interest. Then the similarity between two users can be measured by the similarity scores of feature vectors of the two users. This is also known as the bag-of-words approach. However, this type of approach is quite susceptible to noisy text. This is more severe in the social media context as users are free to publish any posts about their lives, which may not reflect their true topics of interests. Another well-studied method for hidden user topics discovery is the LDA-based method (Latent Dirichlet Allocation). Some of the studies that have used the LDA-based method can be seen in Literature Reference Nos. 1, 4, and 8. Since LDA relies on the bag-of-words assumption, it suffers similar shortcomings. In addition, the computational requirement for LDA is usually high, and it puts significant bottleneck on the scalability of the approach.

Another approach to identifying interests is to analyze network topologies as constructed in both social and topic space. In Literature Reference No. 2, the authors looked into communities of users in the reciprocal Twitter follower network and summarized user interests into several categories. In Literature Reference No. 5, the authors proposed a graph-based framework to link entities mentions in tweets posted by a user via modeling the users' topics of interest. One of the commonality of the aforementioned approaches is that both methods focused on only one type of network topology (e.g., either user-centric or topic-centric network) in their analysis, which does not allow for reviewing bi-relational aspects in multiple networks in a unified manner.

Thus, a continuing need exists for a system that can be used to efficiently and effectively discover user interests through online social media by leveraging topologies of both (user and topic) networks in a unified manner for user interest modeling.

### SUMMARY OF INVENTION

This disclosure provides a system for discovering user interests through online social media. The system includes one or more processors and associated memory (e.g., hard drive, etc.) with instructions encoded thereon. Upon execution of the instructions, the one or more processors perform several operations. For example, during operation, the system generates a confidence matrix F based on user interactions and co-occurring tags on a social media platform (e.g., Twitter, Tumblr, or any other social media platform). The confidence matrix F indicates a likelihood of the users in the social media platform as being interested in a particular topic. Based on such likelihoods, an action can be initiated regarding a particular topic for those users whose likelihood of being interested in the particular topic exceeds a predetermined threshold. For example, the system can generate and present an online advertisement to users regarding a particular topic to those users whose likelihood of being interested in the particular topic exceeds a predetermined threshold (e.g., greater than 50% or any other predetermined threshold as deemed appropriate by an operator).

In another aspect, the system performs operations of constructing a user interaction network W based on a collection of user interactions on a social media platform; constructing a tag co-occurrence network Rₕ based on a collection of co-occurring tags on the social media platform; constructing a topic correlation network R based on the tag co-occurrence network Rₕ; generating a user graph Laplacian L_{g} from the user interaction network W; generating a topic graph Laplacian L_{c} from the topic correlation network R; and generating an initial label assignment matrix Y based on initial known user-topic associations.

Further, in generating a topic correlation network R, the topic correlation network is generated by applying Louvain community detection on Rₕ.

In yet another aspect, the rows of confidence matrix F represent users, and the columns represent topics, such that each entry of the confidence matrix F indicates the likelihood of a user as being interested in a particular topic.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3 is an illustration of a bi-relational graph for user-interest modeling according to various embodiments of the present invention;

FIG. 4A is an illustration of an example tag network;

FIG. 4B is an illustration of an example topic network as associated with the tag network depicted in FIG. 4A;

FIG. 4C is an illustration of an example tag network;

FIG. 4D is an illustration of an example topic network as associated with the tag network depicted in FIG. 4C; and

FIG. 5 is a flowchart illustrating a process for identifying user interests according to various embodiments of the present invention.

### DETAILED DESCRIPTION

The present invention relates to a system for discovering user interests and, more specifically, to a system for discovering user interests through online social media using a bi-directional graph model. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Subsequently, an introduction provides the reader with a general understanding of the present invention. Finally, specific details of various embodiment of the present invention are provided to give an understanding of the specific aspects.

(1) List of Incorporated Literature References

The following references are cited throughout this application. For clarity and convenience, the references are listed herein as a central resource for the reader. The following references are hereby incorporated by reference as though fully set forth herein. The references are cited in the application by referring to the corresponding literature reference number, as follows:
1. Harvey, M., Crestani, F., & Carman, M. J. (2013). Building User Profiles from Topic Models for Personalised. Conference on Information and Knowledge Management (CIKM). San Francisco.
2. Java, A., Song, X., Finin, T., & Tseng, B. (2007). Why we twitter: Understanding microblogging usage and communities. In Proc. 9th WebKDD and 1st SNA-KDD Workshop on Web Mining and Social Network Analysis.
3. Michelson, M., & Macskassy, S. A. (2010). Discovering Users' Topics of Interest on Twitter: A First Look. Proceedings of the fourth workshop on Analytics for noisy unstructured text data (AND). Toronto.
4. Ovsjanikov, M., & Chen, Y. (2010). Topic modeling for personalized recommendation of volatile items. European conference on Machine learning and knowledge discovery in databases: Part II.
5. Shen, W., Wang, J., Luo, P., & Wang, M. (2013). Linking Named Entities in Tweets with Knowledge Base via User Interest Modeling. ACM SIGKDD international conference on Knowledge discovery and data mining. Chicago.
6. Wang, H., Huang, H., & Ding, C. (2009). Image annotation using multi-label correlated Green's function. IEEE 12th International Conference on Computer Vision. Kyoto.
7. Weng, L., & Menczer, F. (2014). Topicality and Social Impact: Diverse Messages but Focused Messengers. CoRR abs/1402.5443.
8. Xu, J., Compton, R., Lu, T.-C., & Allen, D. (2014). Rolling through Tumblr: Characterizing Behavioral Patterns of the Microblogging Platform. ACM Web Science. Bloomington.
9. Xu, J., Jagadeesh, V., & Manjunath, B. (2014). Multi-label Learning with Fused Multimodal Bi-relational Graph. IEEE Transaction on Multimedia.
10. Xu, Z., Lu, R., Xiang, L., & Yang, Q. (2011). Discovering User Interest on Twitter with a Modified Author-Topic Model. IEEE/WIC/ACM International Conferences on Web Intelligence and Intelligent Agent Technology.
11. Jiejun Xu, Tsai-Ching Lu. Toward Precise User-Topic Alignment in Online Social Media. In IEEE International Conference on Big Data (IEEE BigData), Santa Clara, Calif., 2015.
12. D. Zhou, O. Bousquet, T. N. Lal, J. Weston, and B. Schlkopf. Learning with local and global consistency. In NIPS. MIT Press, 2004.
13. X. Zhu. Semi-supervised learning literature survey. In University of Wisconsin Madison, Computer Sciences TR-1530, 2008.
14. R. Compton, D. Jurgens, and D. Allen. Geotagging one hundred million twitter accounts with total variation mini-mization. In IEEE International Conference on Big Data, volume abs/1404.7152, 2014.
15. R. Ottoni, D. B. L. Casas, J. P. Pesce, W. M. Jr., C. Wilson, A. Mislove, and V. Almeida. Of pins and tweets: Investigating how users behave across image- and text-based social net-works. In Proceedings of the Eighth International Conference on Weblogs and Social Media (ICWSM), 2014.
16. L. Weng and F. Menczer. Topicality and impact in social media: Diverse messages, focused messengers. PLoS ONE, 10(2):e0118410, Feb. 2015.
17. Y. Yamaguchi, T. Amagasa, and H. Kitagawa. Tag-based user topic discovery using twitter lists. In International Conference on Advances in Social Networks Analysis and Mining (ASONAM), Kaohsiung, Taiwan, 25-27 Jul. 2011.
18. V. Blondel, J. Guillaume, R. Lambiotte, and E. Mech. Fast unfolding of communities in large networks. J. Stat. Mech, page P10008, 2008.

(2) Principal Aspects

Various embodiments of the invention include three “principal” aspects. The first is a system for to discovering user interests through online social media, and more specifically, to a way of doing so by means of a bi-directional graph model. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

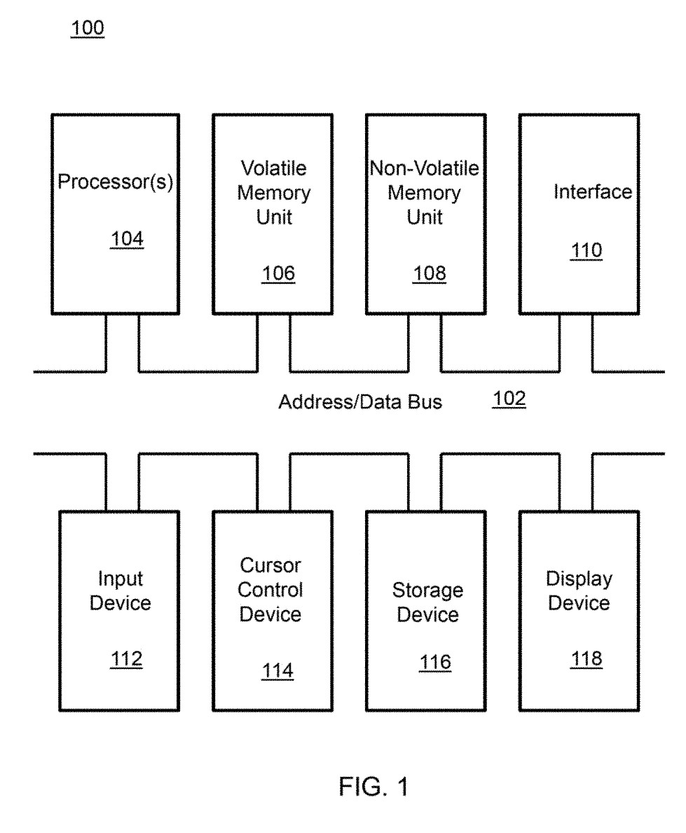

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

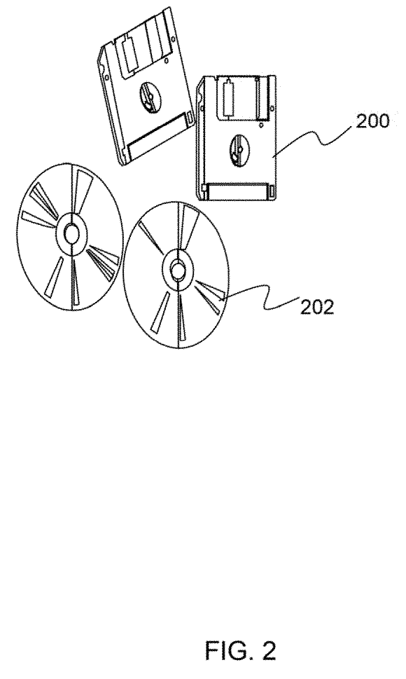

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(3) Introduction

This disclosure describes a technique to discover user interests from online social media (e.g., Tumblr, etc.) based on a bi-relational graph. Specifically, the graph model contains two sub-structures: a network of users and a network of topics (represented by tags). The former is used to capture user interaction (e.g., reblog, etc.) in the social space, and the latter is used to capture tag co-occurrence in the topic space. Subsequently, the user interest discovery problem is formulated as a multi-label learning problem on the proposed bi-relational graph. Given some initial associations of users and tags, the system can estimate the associations for the rest of the user nodes and tag nodes across the two sub-networks.

In some embodiments, a purpose of the system and method is to discover the topics of interest for a particular social media user. This allows for better clustering and search of users based upon their interests. As an example, focus was put on the Tumblr platform with an aim to generate a set of “topic tags” for each user based on what the user posts or reblogs about, and how the user interacts with others. The bi-relational graph representation allows for effective exploitation of user similarity and topic correlation simultaneously. This contrasts with previous work where the two factors are considered in isolation.

As can be appreciated by those skilled in the art, the system and method can be used, for example, for scientific technology analysis (e.g., to predict future collaboration among users based on their interests), for building user profiles from interest models for personalized or marketing services, and other data collection uses.

(4) Specific Details of Various Embodiments

As noted above, this disclosure provides a unique bi-relational graph-based model for user interest discovery. This has a broad range of applications, including accurate user profiling and personalized recommendation. Topics or interests are treated as ‘labels’ in this context, and the problem of user interests discovery is formulated as the multi-label classification problem on graphs. The general process of multi-label classification has been studied extensively in the image annotation domain (see Literature Reference Nos. 6 and 9). The graph-based multi-label classification technique according to various embodiments of the present invention represents a transductive semi-supervised learning process that diffuses the label information (i.e., interests, topics) from a small subset of users to the rest in the graph. Through careful construction of a bi-relational graph, user similarity and label correlation are exploited jointly in the diffusion process. Currently analysis is being conducted on the Tumblr data. The choice of platform is inspired by Literature Reference No. 8, as it shows Tumblr is heavily driven by user interests.

(4.1) Formulation

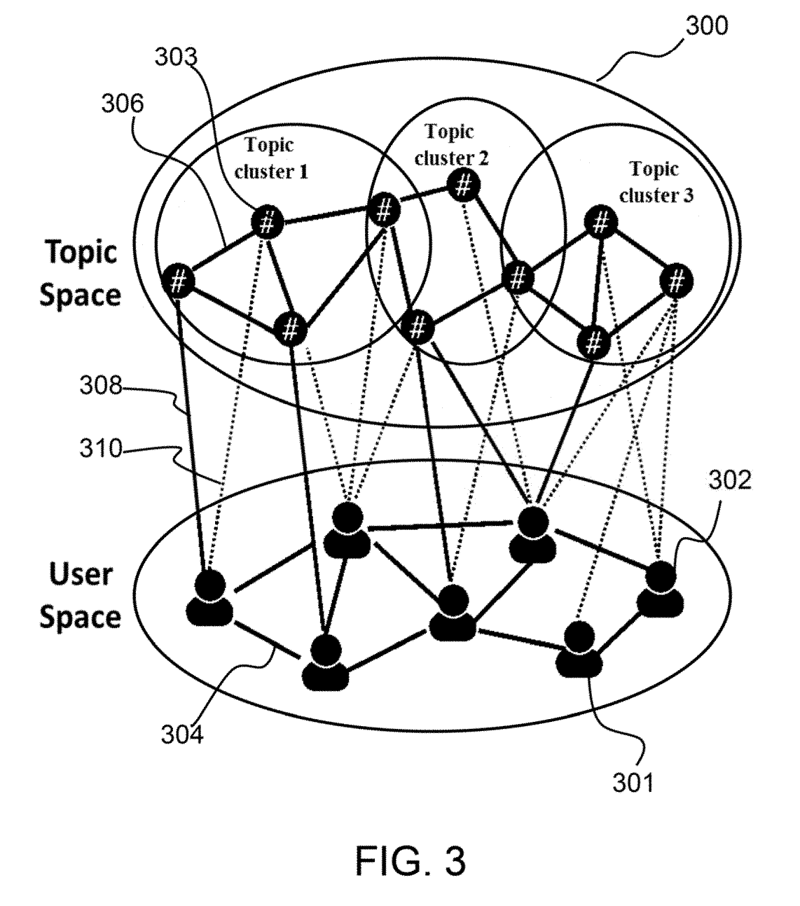

An example construction of the bi-relational graph is shown in FIG. 3. As shown, there are at least two networks, a topic space 300 and a social or user space 302. User space solid lines 304 indicate affinity relationship among user nodes 301 (i.e., user similarity), and topic space solid lines 306 indicate affinity relationship among topic nodes 303 (i.e., topic correlation). The cross network solid lines 308 across the two networks denote the initial label (i.e., topic/interest) association, and the cross network dotted lines 310 denote the label assignment to be estimated. Thus, solid lines 304 and 306 within each of the two sub-graphs indicate social homophily relation and topic correlation, while the solid black lines 308 across two sub-graphs denote the initial known user-topic assignments.

In terms of classification, most existing graph-based semi-supervised learning frameworks attempt to minimize a cost function which takes into account two properties: smoothness of the data (i.e., user) graph and the deviation of initial assignments. Here a third property is introduced into the regularization framework, smoothness in the label (topic) graph. The process for constructing the graph is provided in further detail below.

Suppose that there is a collection of N users U={u₁, u₂, . . . , u_{N}} and K topics of interest={t₁, t₂, . . . , t_{K}}. Assuming that some of the users in U are (partially) labeled for their topics of interest, a goal is to predict the topics of interest for the remaining unlabeled users uᵢ in the collection with the label subset lᵢ⊂T.

The graph-based multi-label learning technique according to various embodiments of the present invention represents a transductive semi-supervised learning process that diffuses the label information from a small subset of nodes to the rest based on the intrinsic graph structure. Note that the terms “topics of interest” and “labels” may be used interchangeably. The basic step in conventional graph-based learning is to construct a graph where vertices represent data instances and edge weights represent affinity between them. The key to graph-based multi-label learning is the prior assumption of consistency: nearby data instances or data instances that lie on the same structure are likely to share the same label. Generally it is formulated in a regularization framework as follows:

F*=argmin_{F}{Ωₛₘₒₒₜₕ(F)+Ωₚᵣᵢₒᵣ(F)}, where F is the to-be-learned matrix containing the label assignments of the graph nodes.

The first term corresponds to a loss function which reflects the consistency assumption by imposing the smoothness constraint on the neighboring labels. The second term is a regularizer for the fitting constraint, which means that initial assigned labels should be changed as little as possible (see Literature Reference Nos. 12 and 13).

In the context of the present system, data instances correspond to users, and their affinity can be characterized by the social interactions or computed based on any other similarity measures such as user demographics and geolocations. Note that the first term of the above regularization framework is in accordance to the social homophily assumption. In addition to the user graph, the conventional graph-based learning framework is augmented by introducing a new graph to emphasize the correlation among topics. In conjunction, the two graphs make up the bi-relational graph model as illustrated in FIG. 3.

Given label association for a small set of data (i.e. initial assignments between user nodes and topic nodes), a goal is to estimate the hidden links between the two types of node in the remaining part. Such a model allows for effective exploitation of the smoothness constraints bon both sub-graphs as well as the interplay between them.

(4.2) Graph Construction

The construction of the user graph in this work is based on the primary interactions in social media platforms. For instance, one can focus on the @mention4 action in Twitter. Twitter users often “@mention” each other by prepending an “@” to the mentioned users name. Although there are other types of interaction such as like and retweet, @mention has been shown to indicate social ties (see Literature Reference No. 14). Similarly, the system focuses on the reblog action on Tumblr (which is the official mechanism to republish the content of another user's posts in Tumbler), as it has been shown to indicate common hobbies and interests among users (see Literature Reference No. 8). In order to obtain strong social ties, in various embodiments, the systems focus on @mention and reblog that are reciprocated (note although the @mention and reblog are used, they are provided as non-limiting examples and the system is not limited to such cues). In other words, a bidirectional edge is only introduced between user i and j if uᵢ @mentions (reblogs) uⱼ and uⱼ @mentions (reblogs) uᵢ at some point in time. The weight of an edge is determined based on the minimum number of reciprocated frequency (i.e., @mentions (reblogs)) between the two users.

The construction of the topic graph is based on the co-occurrence among topics. However, topics are usually not explicitly defined in microblogging platforms, with a few rare exceptions as in Literature Reference No. 15. Alternatively, the system can be devised to consider user defined tags as channels to study topics in social media. This strategy has been studied in existing literature (see Literature Reference Nos. 16 and 17).

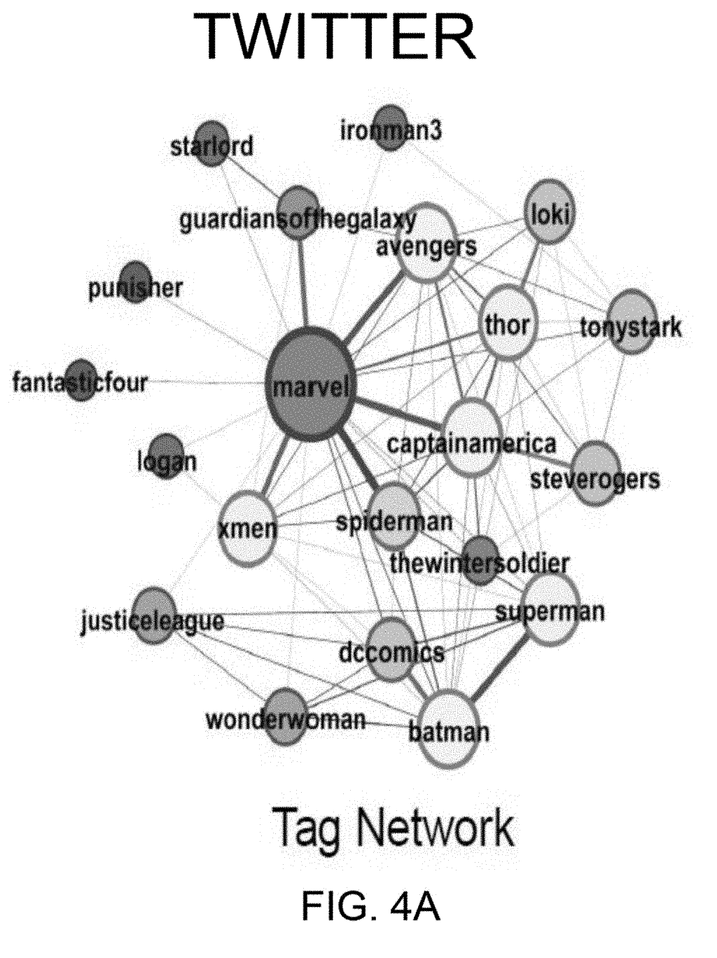

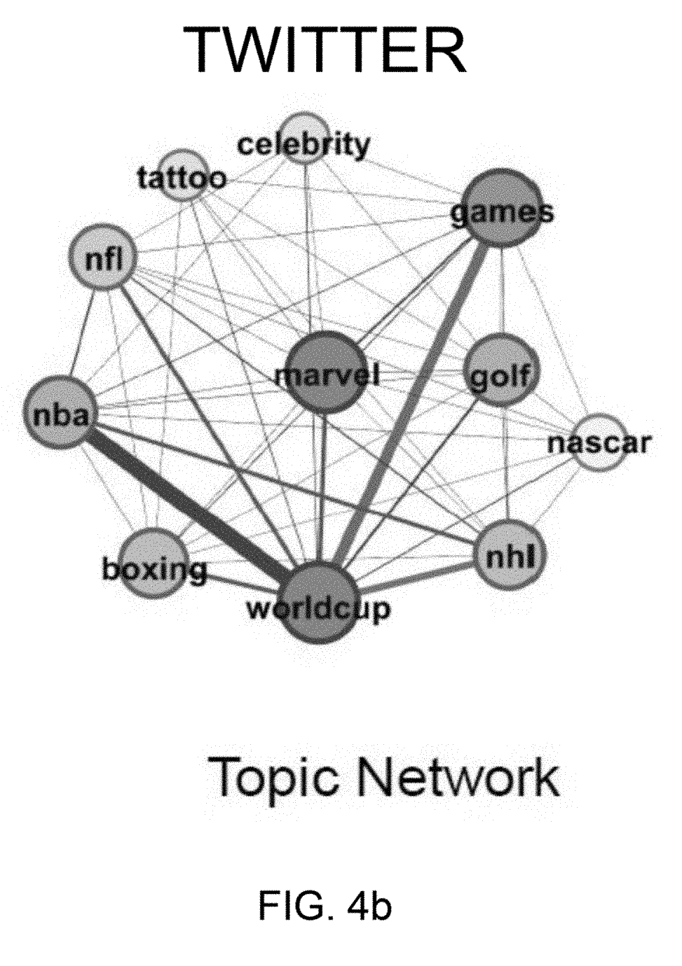

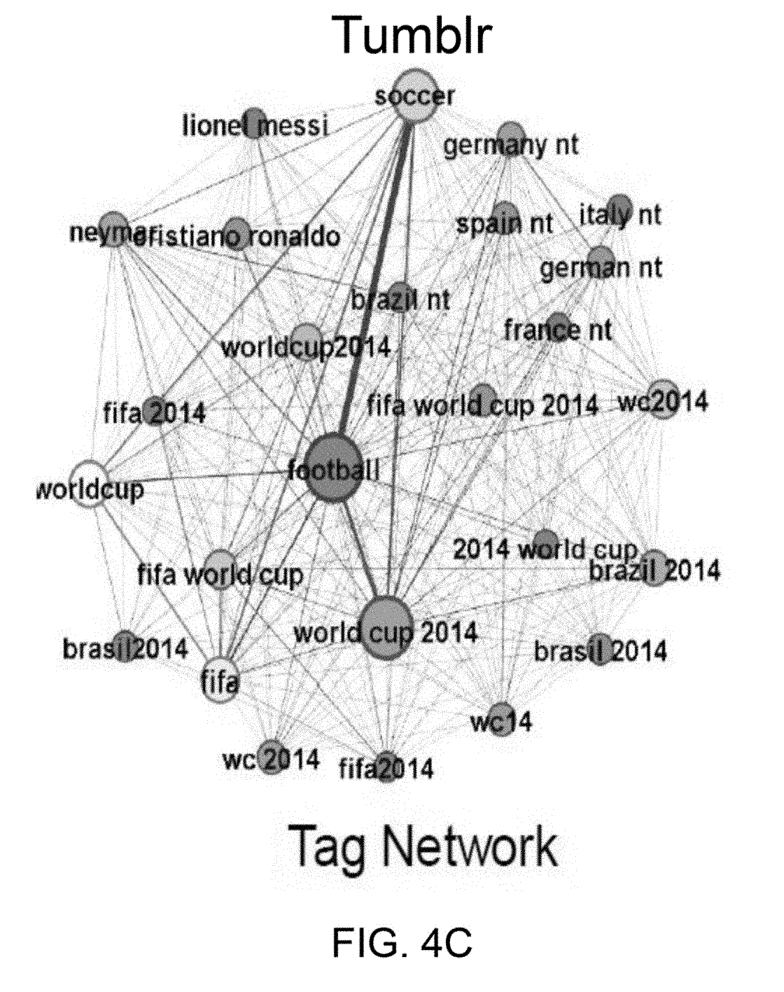

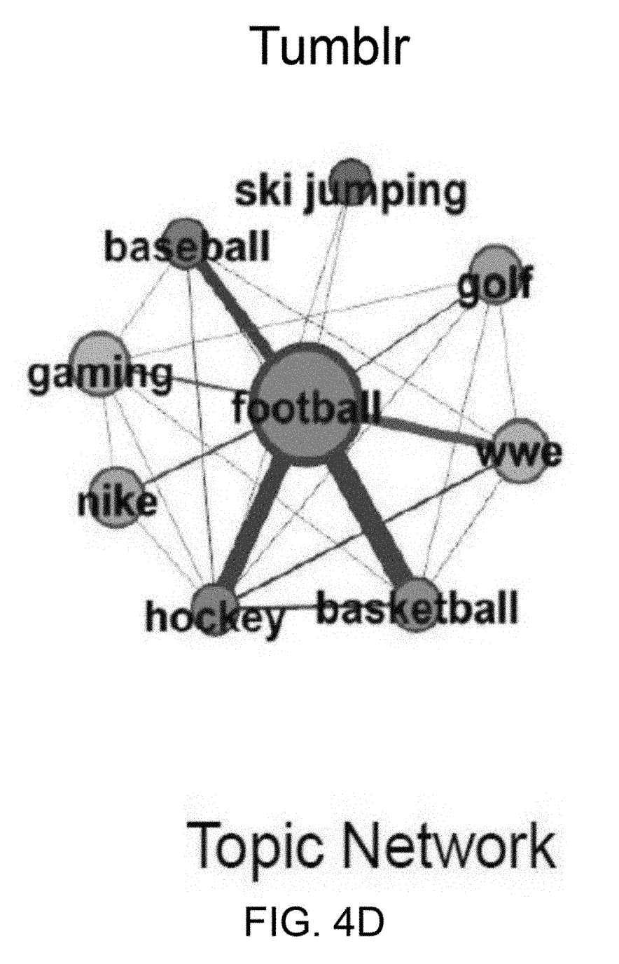

For illustrative purposes, FIGS. 4A and 4C show snapshots of tag co-occurrence networks constructed with Twitter and Tumblr data, while FIGS. 4B and 4D depict corresponding topic networks, respectively. The size and color of a node is proportional to its degree; the width of an edge is proportion to the co-occurrence frequency. The “degree” of a node in the network is the number of connections it has to other nodes. In the example as shown in FIGS. 4A through 4D, the color changes gradually from green to purple to white. In this non-limiting example, the greener a node is, the higher degree (i.e., connected to many others, or center node) it is; on the other hand, white/purple colors indicate the corresponding nodes are less connected to others (i.e., peripheral nodes).

As can be seen, the tags in each of the networks are related to a single coherent topic. For instance, the tags in the Twitter network are related to “Marvel”, which is a popular comic publisher. The nodes in the graph include comic titles (and their name variations), comic characters, and cast members of comic book adaptation movies. The same observation can be seen from the sample tag network derived from the Tumblr platform, where nodes related to “football” often co-occur together.

Since tags on social media sites are invented autonomously by millions of content generators, there is no predefined consensus on how to group them into topics. Multiple duplicate tags may be developed to represent the same event, theme, or object. For instance, #loki, #thor, #odin, #asgard are all related to the fictional characters in a Marvel movie; #worldcup2014, #brazilwc2014, #wc2014, #fifawc14 are all about the major soccer event that occurred in June 2014. In order to reduce duplication and noise, raw tags can be aggregated and abstracted to a more general level clusters of semantically related tags, referred to as topics. These clusters are detected by finding communities in the tag-based co-occurrence network. For example, the Louvain community detection method (see Literature Reference No. 18) can be used to identify the topic clusters because of its computational efficiency. The basic idea of the Louvain method is to repeatedly find small communities by optimizing modularity locally on all nodes, then group each of these small communities into a single node. FIGS. 4B and 4D show examples of the resulting topic graphs. Strong topic locality can be observed.

(4.3) Multi-Label Learning on the Bi-Relational Graph

As mentioned above, conventional graph-based learning framework minimizes a cost function with two terms. Introducing a new topic graph to the framework leads to the updated regularization framework regarding F as follows:

Let W be a N×N affinity matrix denoting the data graph constructed with N data points (users), and R be a K×K affinity matrix denoting the label graph constructed for K topics. The frequency-based weights in W and R are normalized to the same dynamic range. Let F=(F₁, . . . , F_{N})^{T}=(C₁, . . . , C_{K}) be a N×K matrix denoting the final association between every user topic pairs. (C₁, . . . , C_{K}) are the columns ofF, corresponding to the K labels. Similarly let Y=(Y₁, . . . , Y_{N}) be an N×K matrix denoting the initial label assignments. Each Yᵢⱼ has 1 or 0 as the possible values: 1 if user i is labeled with topic j, 0 if it is unlabeled. The overall cost function is expressed as:

$$Ω ( F ) = \underbrace{\frac{1}{2} η {\sum }_{i , j}^{N} {W}_{ij} {‖ \frac{{F}_{i}}{\sqrt{{D}_{ii}}} - \frac{{F}_{j}}{\sqrt{{D}_{jj}}} ‖}^{2}}_{Smoothness on user graph} + \underbrace{\frac{1}{2} μ {\sum }_{i , j} {W}_{ij}^{*} {‖ \frac{{C}_{i}}{\sqrt{{D}_{ii}^{′}}} - \frac{{C}_{j}}{\sqrt{{D}_{jj}^{′}}} ‖}^{2}}_{Smoothness on topic graph} + \underbrace{{{\sum }_{i}}^{N} {‖ {F}_{i} - {Y}_{i} ‖}^{2}}_{prior constraint} , \qquad ( 1 )$$

where D and D′ are both diagonal matrix whose (i, i) entries equal to the sum of the i-th row of W and R, i.e.,

$${D}_{ii} = {\sum }_{j = 1}^{N} {W}_{ij} and {D}_{ii}^{′} = {\sum }_{j = 1}^{K} {R}_{ij} .$$

The solution of F can be found by minimizing the above cost function.

The first term of the above equation (1) is the smoothness constraint on the user graph. Minimizing it means neighboring vertices should share similar labels. For instance, if two users are close to each other based on their frequent reblog activities (e.g., @mention, reblog), they will probably have common interests (thus with similar labels). The second term is the smoothness constraint on the topic or label graph. Minimizing it means neighboring vertices should include similar users. For instance, if two topics are highly correlated with each other, then they are likely to be of interest to the same set of users. The third term indicates that the initially known user topic pairs should be changed as little a possible.

η and μ are two constants controlling the trade-off of the regularization terms. If μ is set to zero, it means to ignore the correlation among topics, and the formulation is reduced to traditional multi-label learning on a single (social) graph.

The first term of the above cost function can be rewritten as:

$$\frac{1}{2} η {{\sum }_{i , j}}^{N} {W}_{ij} {‖ \frac{{F}_{i}}{\sqrt{{D}_{ii}}} - \frac{{F}_{j}}{\sqrt{{D}_{jj}}} ‖}^{2} = \frac{1}{2} η ( {\sum }_{i = 1}^{N} {F}_{i}^{T} {F}_{i} + {\sum }_{j = 1}^{N} {F}_{j}^{T} {F}_{j} - 2 {\sum }_{i , j = 1}^{N} \frac{{W}_{i , j} {F}_{i}^{T} {F}_{j}}{\sqrt{{D}_{i} {D}_{j}}} ) = η ( {\sum }_{i = 1}^{N} {F}_{i}^{T} {F}_{i} - {\sum }_{i , j = 1}^{N} \frac{{W}_{i , j} {F}_{i}^{T} {F}_{j}}{\sqrt{{D}_{i} {D}_{j}}} ) = η tr ( {F}^{T} ( I - {D}^{- 1 / 2} {WD}^{- 1 / 2} ) F ) . \qquad ( 2 )$$

Similarly, the second and third terms of the cost function can be rewritten in a matrix form with several algebraic steps. Thus, the original cost function above can be written in a more concise form as:

Ω(F)=ηtr(F^{T}L_{g}F)+μtr(FLcF^{T})+tr((F−Y)^{T}(F−Y)), (3)

where L_{g}=I−D^{-1/2}WD^{-1/2} and L_{c}I−D′^{-1/2}RD′^{-1/2}. They are the Normalized Laplacian of user graph and topic graph respectively.

By applying the following matrix properties:

$$\frac{\partial tr ( {X}^{T} AX )}{\partial X} = ( A + {A}^{T} ) X , \frac{\partial tr ( {XAX}^{T} )}{\partial X} X ( A + {A}^{T} ) , \qquad ( 4 )$$

the equation can be differentiated with respect to F as follows:

$$\frac{\partial Ω ( F )}{\partial F} = η LF + μ {FL}_{C} + ( F - Y ) . \qquad ( 5 )$$

This is because both Lg and Lc are symmetric matrices. The solution for F can be obtained by requiring

$$\frac{\partial Ω ( F )}{\partial F}$$

to zero. With some simple algebraic steps, it becomes apparent that (ηL_{g}+I)F+μFL_{c}=Y,
which is essentially a matrix equation with the form of AX+XB=C. Solution to the equation can be easily obtained from existing numerical libraries, such as Linear Algebra PACKage (LAPACK) and Matlab. LAPACK is a software package provided by Univ. of Tennessee; Univ. of California, Berkeley; Univ. of Colorado Denver; and NAG Ltd. Note that Fᵢⱼ is essentially a confidence value of user uᵢ being interested in topic tⱼ.

Once F or Fᵢⱼ is found, labels can be assigned (i.e., topics of interest) to users using simple thresholds. Basically a user with a higher value can be assigned to the corresponding topic with higher confidence. The overall process for inferring user's topics of interest is summarized in the Algorithm below.

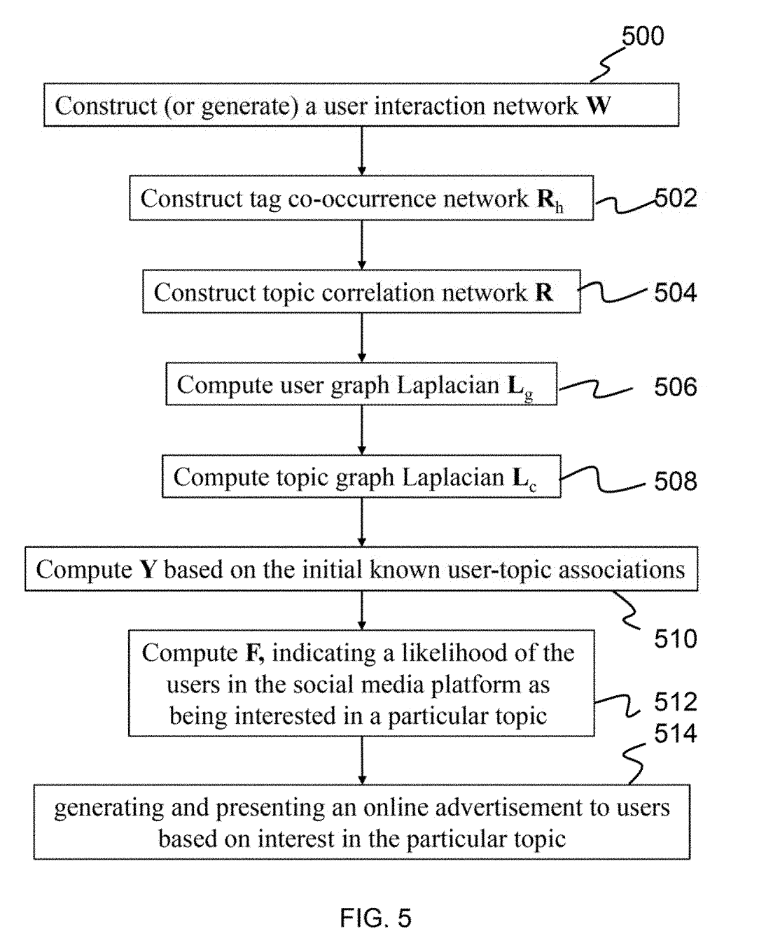

Input: Set E={(eᵢ^{a}, eᵢ^{b}, wᵢ)|i=1, 2, . . . , N_{[E]}} containing the collection of user interactions, e.g., eᵢ^{a} reblogs eᵢ^{b} for wᵢ times. Set H={(hⱼ¹, hⱼ², . . . hⱼⁿ^{_{[j]}})|j=1, 2, . . . , N_{[H]}} containing the collection of co-occurring tags, e.g., hⱼ¹, . . . hⱼⁿ^{_{[j]}} are associated to the j^{th} social media post. Output: Confidence matrix F, where Fᵢⱼ is indicates the probability of user uᵢ interested in topic tⱼ. As shown in FIG. 5, the algorithm proceeds according to the following steps:
1. Construct (or generate) a user interaction network W 500 from E.
2. Construct tag co-occurrence network Rₕ 502 from H.
3. Construct topic correlation network R 504 by applying Louvain community detection on Rₕ.
4. Compute user graph Laplacian L_{g} 506 from W.
5. Compute topic graph Laplacian L_{c} 508 from R.
6. Compute Y 510 based on the initial known user-topic associations.
7. Compute F 512 by minimizing the cost function in Eq. (3), i.e., solve the following matrix equation:

ηL_{g}F+μFL_{c}+(F−Y)=0.
8. Return the most confidence user-topic pairs by sorting and ranking entries in F.

The system can then be used to characterize social media users' topics of interest by estimating the F matrix using information derived from online social network as described in the above algorithm. The rows of the F matrix represent users, and the columns represent topics. Each entry of the matrix indicates the likelihood of a user interested in a particular topic.

This invention is important because the research outcome allows for better clustering and search of online users, and it has direct impacts on personalization, recommendation, and many other aspects of online experience enhancement. The system has been applied on characterizing online users' topics of interested on two social media platforms—Twitter and Tumblr. In both cases, substantial improvements were obtained compared to existing methods. For example, the process as described herein is supported by the experimental studies as described in Literature Reference No. 11.

As noted above, there are several applications in which the system can be implemented by automatically initiating an action regarding a particular topic for those users whose likelihood of being interested in the particular topic exceeds a predetermined threshold (e.g., greater than 50% likelihood). For example, based on the user-topic pairs and ranked entries in F, the system can then be used to market services or products to particular individuals based on their interests, such as by automatically generating and presenting an online advertisement 514 to users regarding a particular topic to those users whose likelihood of being interested in the particular topic exceeds the predetermined threshold. As a non-limiting example, if a particular user has a high likelihood of interest (e.g., greater than 50%) in topics associated with Marvel characters, then banner ads for upcoming movies associated with cartoon characters can be presented through the internet to the user. As another non-limiting example, if a particular user has a high likelihood of interest in topics associated with football games, such as the World Cup, then banner ads for travel packages to various football games can be presented to the user (e.g., a banner ad for flights and hotel accommodations to the host city of an international football event). As yet another non-limiting example, if a user has a high likelihood of interest in topics associated with automobile performance, then mailings or banner ads can be presented to the user regarding new vehicles.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for identifying user interests through social media, the system comprising:
one or more processors and a memory, the memory being a non-transitory computer-readable medium having executable instructions encoded thereon, such that upon execution of the instructions, the one or more processors perform operations of:
generating a confidence matrix F based on user interactions and co-occurring tags on a social media platform, the confidence matrix F indicating a likelihood of the users in the social media platform as being interested in a particular topic; and
initiating an action regarding a particular topic for those users whose likelihood of being interested in the particular topic exceeds a predetermined threshold.

2. The system as set forth in claim 1, further comprising operations of:
constructing a user interaction network W based on a collection of user interactions on a social media platform;
constructing a tag co-occurrence network Rₕ based on a collection of co-occurring tags on the social media platform;
constructing a topic correlation network R based on the tag co-occurrence network Rₕ;
generating a user graph Laplacian L_{g} from the user interaction network W;
generating a topic graph Laplacian L_{c} from the topic correlation network R; and
generating an initial label assignment matrix Y based on initial known user-topic associations.

3. The system as set forth in claim 2, wherein in generating a topic correlation network R, the topic correlation network is generated by applying Louvain community detection on Rₕ.

4. The system as set forth in claim 3, wherein the rows of confidence matrix F represent users, and the columns represent topics, such that each entry of the confidence matrix F indicates the likelihood of a user as being interested in a particular topic.

5. The system as set forth in claim 4, wherein initiating an action further comprises operations of generating and presenting an online advertisement to users regarding a particular topic to those users whose likelihood of being interested in the particular topic exceeds a predetermined threshold.

6. The system as set forth in claim 1, wherein the rows of confidence matrix F represent users, and the columns represent topics, such that each entry of the confidence matrix F indicates the likelihood of a user as being interested in a particular topic.

7. The system as set forth in claim 1, wherein initiating an action further comprises operations of generating and presenting an online advertisement to users regarding a particular topic to those users whose likelihood of being interested in the particular topic exceeds a predetermined threshold.

8. A method for identifying user interests through social media, the method comprising acts of:
generating, with one or more processors, a confidence matrix F based on user interactions and co-occurring tags on a social media platform, the confidence matrix F indicating a likelihood of the users in the social media platform as being interested in a particular topic; and
initiating, with the one or more processors, an action regarding a particular topic for those users whose likelihood of being interested in the particular topic exceeds a predetermined threshold.

9. The method as set forth in claim 8, further comprising operations of:
constructing a user interaction network W based on a collection of user interactions on a social media platform;
constructing a tag co-occurrence network Rₕ based on a collection of co-occurring tags on the social media platform;
constructing a topic correlation network R based on the tag co-occurrence network Rₕ;
generating a user graph Laplacian L_{g} from the user interaction network W;
generating a topic graph Laplacian L_{c} from the topic correlation network R; and
generating an initial label assignment matrix Y based on initial known user-topic associations.

10. The method as set forth in claim 9, wherein in generating a topic correlation network R, the topic correlation network is generated by applying Louvain community detection on Rₕ.

11. The method as set forth in claim 10, wherein the rows of confidence matrix F represent users, and the columns represent topics, such that each entry of the confidence matrix F indicates the likelihood of a user as being interested in a particular topic.

12. The method as set forth in claim 11, wherein initiating an action further comprises acts of generating and presenting an online advertisement to users regarding a particular topic to those users whose likelihood of being interested in the particular topic exceeds a predetermined threshold.

13. The method as set forth in claim 8, wherein the rows of confidence matrix F represent users, and the columns represent topics, such that each entry of the confidence matrix F indicates the likelihood of a user as being interested in a particular topic.

14. The method as set forth in claim 8, wherein initiating an action further comprises acts of generating and presenting an online advertisement to users regarding a particular topic to those users whose likelihood of being interested in the particular topic exceeds a predetermined threshold.

15. A computer program product for identifying user interests through social media, the computer program product comprising:
a non-transitory computer-readable medium having executable instructions encoded thereon, such that upon execution of the instructions by one or more processors, the one or more processors perform operations of:
generating a confidence matrix F based on user interactions and co-occurring tags on a social media platform, the confidence matrix F indicating a likelihood of the users in the social media platform as being interested in a particular topic; and
initiating an action regarding a particular topic for those users whose likelihood of being interested in the particular topic exceeds a predetermined threshold.

16. The computer program product as set forth in claim 15, further comprising operations of:
constructing a user interaction network W based on a collection of user interactions on a social media platform;
constructing a tag co-occurrence network Rₕ based on a collection of co-occurring tags on the social media platform;
constructing a topic correlation network R based on the tag co-occurrence network Rₕ;
generating a user graph Laplacian L_{g} from the user interaction network W;
generating a topic graph Laplacian Le from the topic correlation network R;
generating an initial label assignment matrix V based on initial known user-topic associations.

17. The computer program product as set forth in claim 16, wherein in generating a topic correlation network R, the topic correlation network is generated by applying Louvain community detection on Rₕ.

18. The computer program product as set forth in claim 17, wherein the rows of confidence matrix F represent users, and the columns represent topics, such that each entry of the confidence matrix F indicates the likelihood of a user as being interested in a particular topic.

19. The computer program product as set forth in claim 18, wherein initiating an action further comprises operations of generating and presenting an online advertisement to users regarding a particular topic to those users whose likelihood of being interested in the particular topic exceeds a predetermined threshold.

20. The computer program product as set forth in claim 15, wherein the rows of confidence matrix F represent users, and the columns represent topics, such that each entry of the confidence matrix F indicates the likelihood of a user as being interested in a particular topic.

21. The computer program product as set forth in claim 15, wherein initiating an action further comprises operations of generating and presenting an online advertisement to users regarding a particular topic to those users whose likelihood of being interested in the particular topic exceeds a predetermined threshold.
